(19) United States
(12) Patent Application Publication
(10) Pub. No.: US 2013/0262497 A1
(43) Pub. Date: Oct. 3, 2013

(54) Inspection Tool

(71) Applicant: CATERPILLAR INC., Peoria, IL (US)

(72) Inventors: Chad William Case, Knoxville, IL (US); Gerald Lee Green, Chillicothe, IL (US); Gregory T. Johnson, Cuba, IL (US); Mark Juchems, Tremont, IL (US); Michael E. Kamp, Good Field, IL (US); Michael David Young, Morton, IL (US); Steven Bergstrom, Washington, IL (US)

(73) Assignee: Caterpillar Inc., Peoria, IL (US)

(21) Appl. No.: 13/854,543

(22) Filed: Apr. 1, 2013

Related U.S. Application Data
(60) Provisional application No. 61/619,110, filed on Apr. 2, 2012.

(51) Int. Cl. G06F 17/24; G06F 17/30

(52) U.S. Cl. CPC G06F 17/243; H04L 67/42; G06F 17/30256
USPC 707/758; 715/224; 709/203

(57) ABSTRACT

An electronic tool is disclosed to collect form data to determine if physical adjustments are required by a physical object. The forms may be device agnostic and the data may be stored in a way that the forms may be created, reviewed and edited on virtually any device that can execute a web browser and have periodic network access.

### RELATED CASES AND CLAIM OF PRIORITY

This patent claims priority to U.S. Provisional Application 61/619,110, “Inspection Tool,” filed on Apr. 2, 2012, which is hereby incorporated by reference for all purposes.

### BACKGROUND

In the past, when a device was inspected, paper copies of inspection forms were created. In some instances, carbon paper was used to create copies. The copies were often lost, misplaced or filed away in a file. The detail of past inspections was difficult to obtain if it was obtainable at all.

At the same time, many people have a need to review the data from device inspections. Owners could use the data to help determine when additional maintenance may be needed. Dealers could use the data to determine when services may be offered to certain owners. Manufacturers could use the data to determine trends and identify problems with the devices. Inspectors could use the data to better perform inspections as they would know of past issues with the device at hand but also with devices in general.

### SUMMARY

An electronic tool is disclosed to collect form data to determine if physical adjustments to a physical object or device are required. The forms may be device agnostic and the data may be stored in a way that the forms may be created, reviewed, and edited on virtually any computing platform that can execute a web browser and have periodic network access.

In addition, the method may store the data in a form that is easy to search such as a database. In this way, the data may be easily reviewed by a variety of interested parties. The data may be obtained by asking questions which are answered by an inspector. The answers also may be photos or other electronic data. The data may be stored in a central location such that it is available to be used by a variety of interested and qualified personnel. The data may be analyzed to find existing issues that should be inspected by to identify issues that may occur in the future. Inspections with qualified inspectors may be scheduled and the cost of repairs, if necessary, may be estimated. As a result, physical changes to an object may be directed.

These and other benefits will become apparent from the specification, the drawings and the claims.

### BRIEF DESCRIPTION OF THE DRAWINGS

FIG. 1 is a flowchart illustrating blocks that may be executed to collect and store form data;

FIG. 2 is a flowchart illustrating blocks that may executed for reviewing images for useful data;

FIG. 3 is a flowchart illustrating blocks that may executed for storing inspection data;

FIG. 4 is a flowchart illustrating blocks that may executed for reviewing areas of concern from an inspection;

FIG. 5 is a flowchart illustrating blocks that may executed for determining an inspector to be selected;

FIG. 6 is a flowchart illustrating blocks that may executed for proactively determining issues to be addressed

FIG. 7 is an illustration of a sample object;

FIG. 8 is an illustration of components that may be part of the computing system;

FIG. 9 is an illustration of a sample portable computing device;

FIG. 10 is an illustration of a sample server computer;

FIG. 11 is an illustration of a form used in the system;

FIG. 12 is an illustration of a form used in the system;

FIG. 13 is an illustration of a form used in the system to assign a task to an inspector;

FIG. 14 is an illustration of a form used in the system;

FIG. 15 is an illustration of a form used in the system to designate an action;

FIG. 16 is an illustration of a form used in the system to add more comments or images; and

FIG. 17 is an illustration of adding an image to a form.

### DESCRIPTION

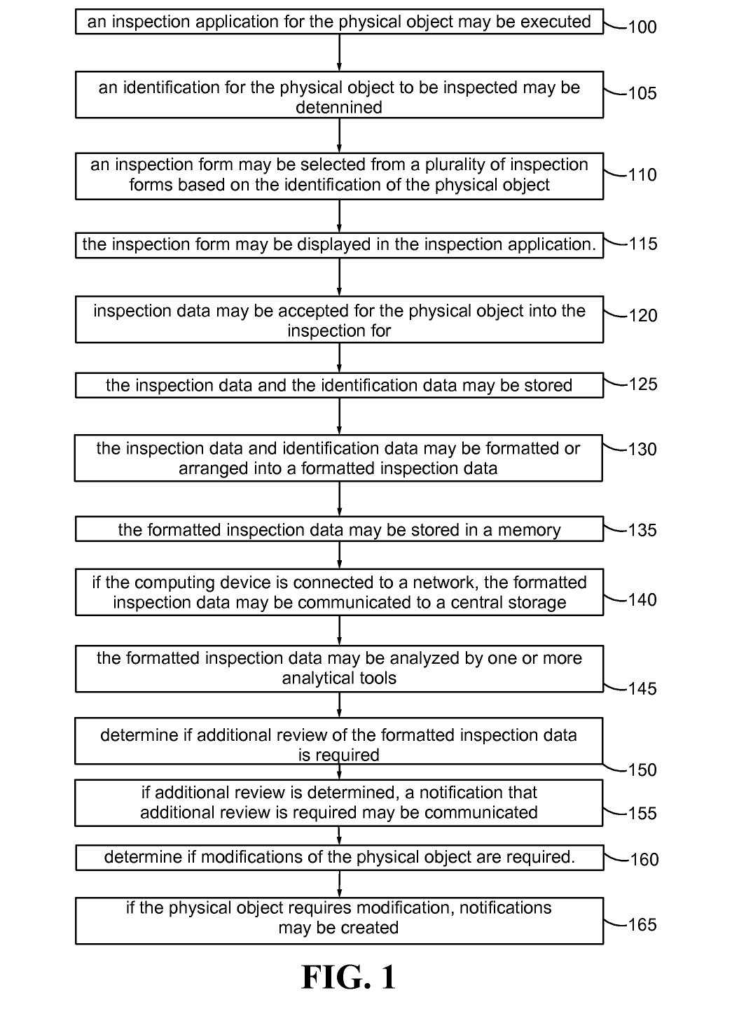

FIG. 1 illustrates a sample method of collecting inspection data for a physical object. The physical object 700 may be virtually any object. In some embodiments, the object 700 is something large that is not easy to transport to a dealer or to an inspector. Examples include houses, earthmovers, excavators, fork lifts, and other objects that are not easy to transport.

At block 100, an inspection application for the physical object 700 may be executed on a computing device. The application may be created in a way such that the inspection application may execute if the computing device is not in communication with a network. Some previous systems would only operate if access to remote data was available. The current system may use HTML5 and web services according to the web services standard (which may be found at http://www.w3.org/2002/ws/) and locally stored forms to obtain data. For example, the inspection may be of a known earthmover. There may be a standard form 1200 to inspect an earthmover between shifts. The form 1200 may be stored remotely on a server or in a cloud of servers or it may be stored locally.

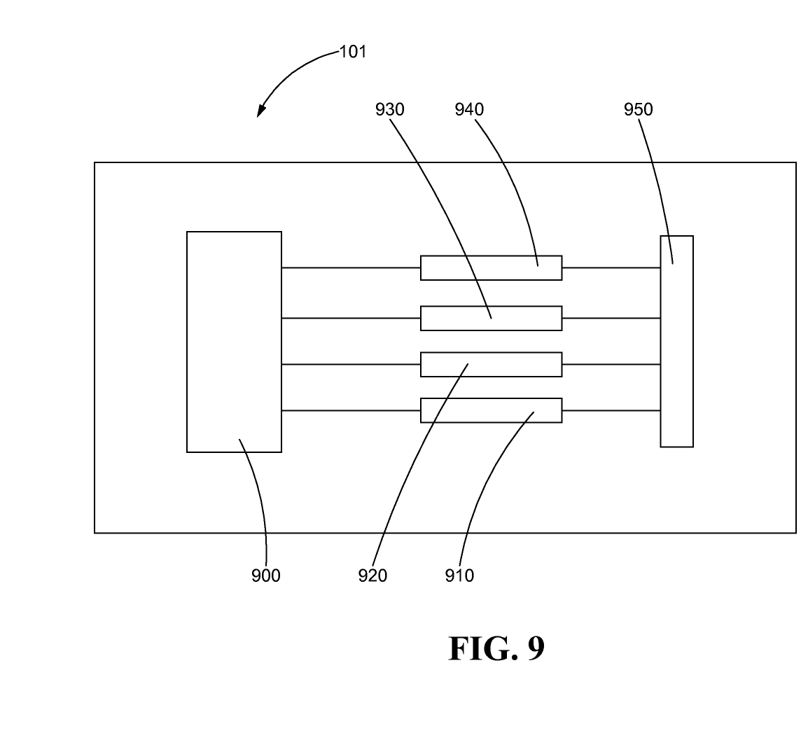

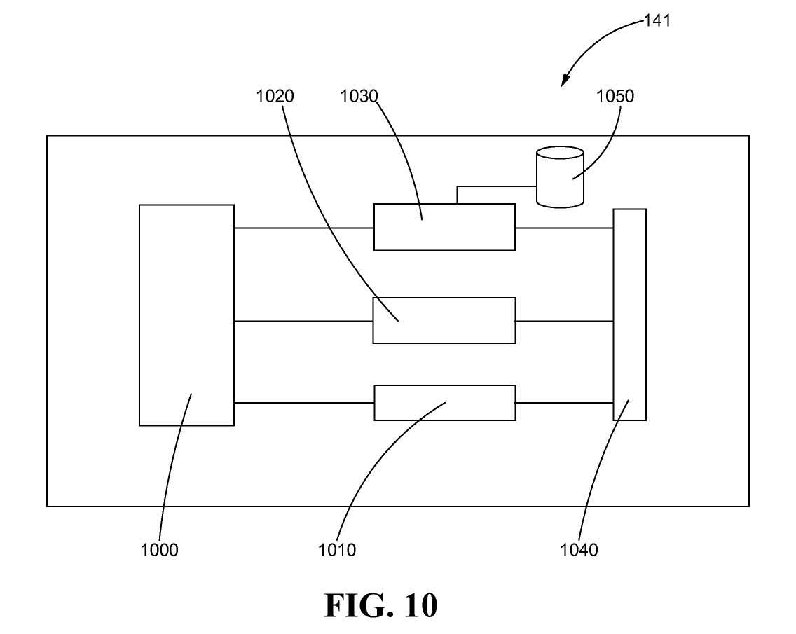

Virtually any computing device 101 141 such as the devices in FIGS. 9 and 10 that can support a web browser and HTML5 and web services may be used to display an inspection form 1200 and collect information. HTML5 and web services are device agnostic and may operate in a browser type fashion. It may display data, accept data in input fields and store the inputted data. The data may be stored and communicated when the computing device is in network communication or when a synchronized selection is made and network access is available. More information on HTML5 may be found at http://w3c-html.com/html5.html.

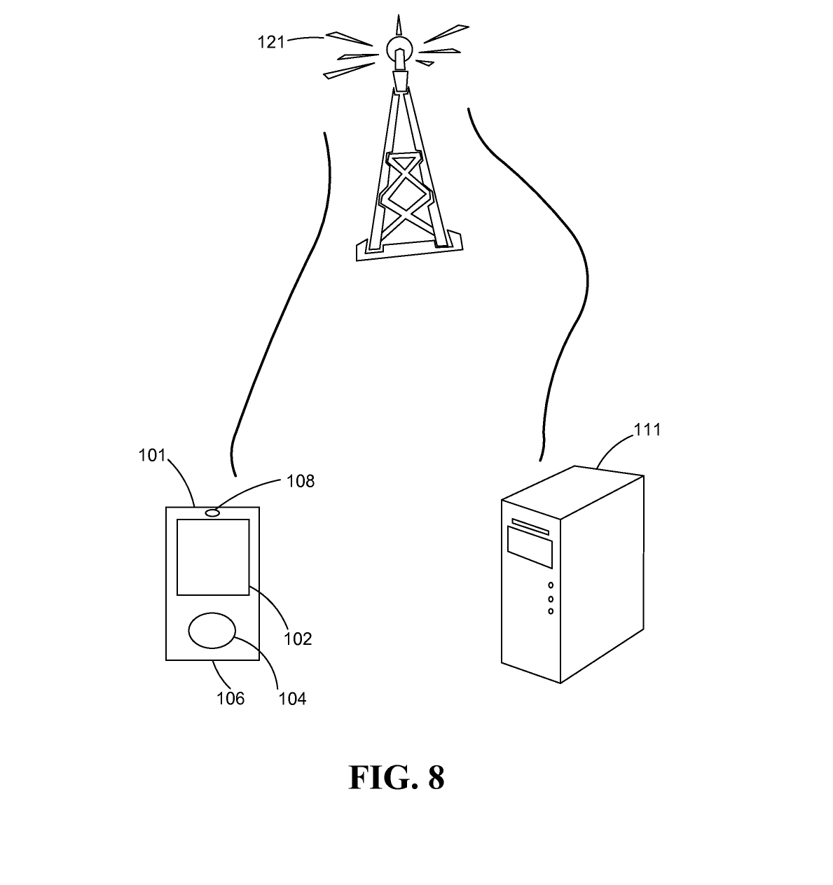

FIG. 8 may be a high level illustration of some of the elements of a sample computing system. The computing system may be a dedicated computing device, a dedicated portable computing device, an application on the computing device, an application on the portable computing device or a combination of all of these. In addition, the application may be obtained in a variety of ways such as from an app store, from a manufacturer, from a dealer or from an inspector. There may be various versions of the application to take advantage of the benefits of different computing devices, different languages and different API platforms.

In one embodiment, a portable computing device 101 may be a device that operates using a portable power source such as a battery. The portable computing device 101 may also have a display 102 which may or may not be a touch sensitive display. More specifically, the display 102 may have a capacitance sensor, for example, that may be used to provide input data to the portable computing device 101. In other embodiments, an input pad 104 such as arrows, buttons, scroll wheels, keyboards, etc., may be used to provide inputs to the portable computing device 101. In addition, the portable computing device 101 may have a microphone 106 which may accept and store verbal data and a camera 108 to accept images.

The portable computing device 101 may be able to communicate with a computing device 141 or a plurality of computing devices 141 that make up a cloud of computing devices 111. The portable computing device 101 may be able to communicate in a variety of ways. In some embodiments, the communication may be wired such as through an Ethernet cable, a USB cable or RJ6 cable. In other embodiments, the communication may be wireless such as through wifi (802.11 standard), Bluetooth®, cellular communication or near field communication devices. The communication may be direct to the computing device 141 or may be through a communication network 121 such as cellular service, through the Internet, through a private network, through Bluetooth, etc. FIG. 9 may be a simplified illustration of the physical elements that make up a portable computing device 101.

The physical elements that make up the computing device 141 may be further illustrated in FIG. 10. At a high level, the computing device 141 may include a digital storage such as a magnetic disk, an optical disk, flash storage, non-volatile storage, etc. Structured data may be stored in the digital storage such as in a database.

FIG. 9 may be a sample portable computing device 101 that is physically configured according to be part of the system. The portable computing device 101 may have a processor 900 that is physically configured according to computer executable instructions. It may have a portable power supply 910 such as a battery which may be rechargeable. It may also have a sound and video module 920 which assists in displaying video and sound and may turn off when not in use to conserve power and battery life. The portable computing device 101 may also have volatile memory 930 and non-volatile memory 940. There also may be an input/output bus 950 that shuttles data to and from the various user input devices such as the microphone 106, the camera 108 and other inputs 104, etc. It also may control communicating with the networks, either through wireless or wired devices. Of course, this is just one embodiment of the portable computing device 101 and the number and types of portable computing devices 101 is limited only by the imagination.

FIG. 10 may be a sample server 141 that is physically configured according to be part of the system. The server 141 may have a processor 1000 that is physically configured according to computer executable instructions. It may also have a sound and video module 1010 which assists in displaying video and sound and may turn off when not in use to conserve power and battery life. The server 141 may also have volatile memory 1020 and non-volatile memory 1030. The database 1050 may be stored in the memory 1020 or 1030 or may be separate. The database 1050 may also be part of a cloud of computing device 141 and may be stored in a distributed manner across a plurality of computing devices 141. There also may be an input/output bus 1040 that shuttles data to and from the various user input devices such as the microphone 106, the camera 108, the inputs 104, etc. The input/output bus 1040 also may control of communicating with the networks, either through wireless or wired devices. Of course, this is just one embodiment of the server 141 and the number and types of server 141 is limited only by the imagination.

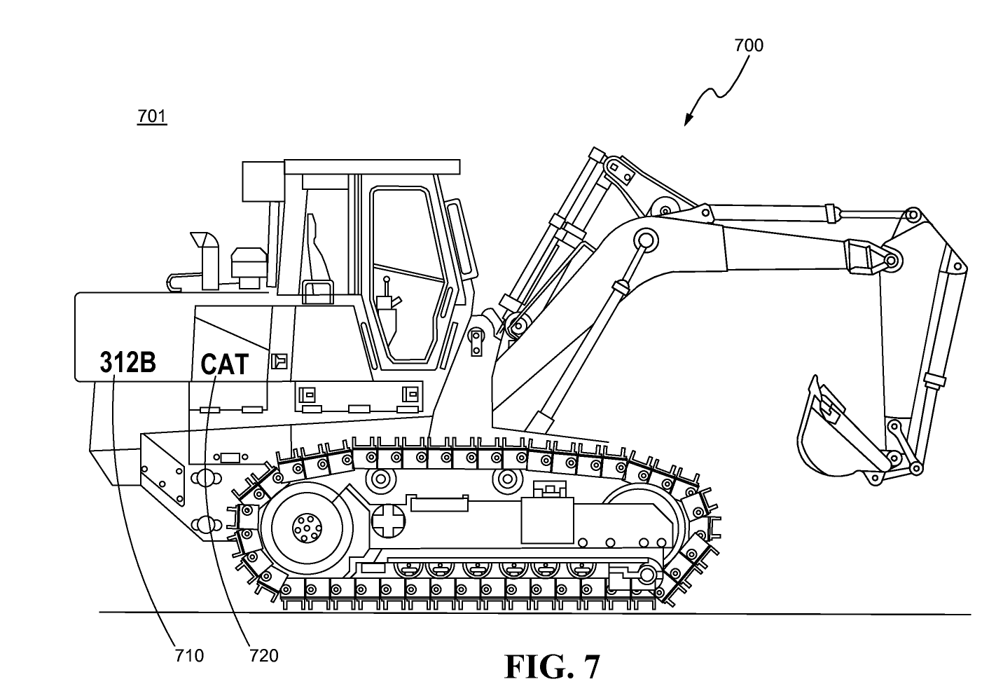

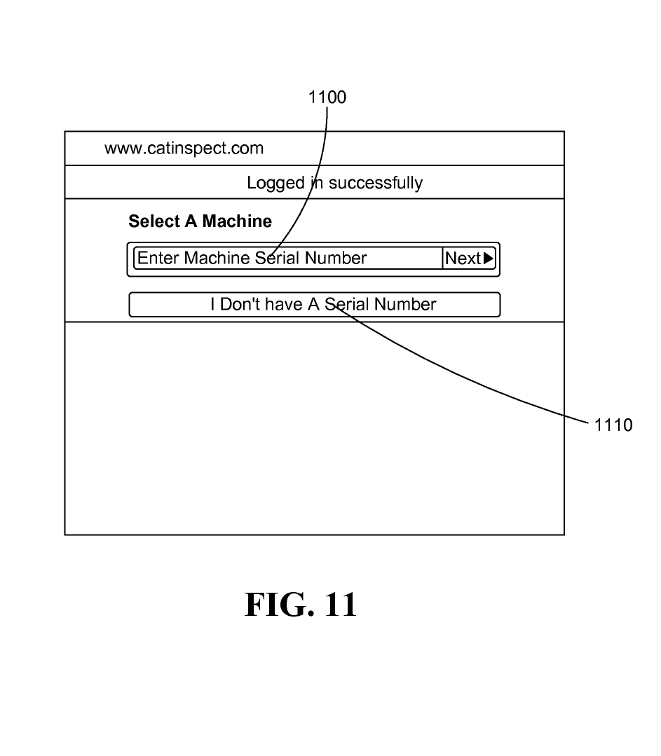

Referring again to FIG. 1, at block 105, an identification for the physical object 700 to be inspected may be determined. Referring to FIG. 11, if the identification 1100 (FIG. 11) is known, it may simply be entered into a computing device 101. The identification may be created in a variety of ways. In some embodiments, the serial number from the physical object, such as a grader, may be entered. In other embodiments, another identifier may be used such as “123 Smith Drive”. In other embodiments, the identification may be more general such as a model number 710 (FIG. 7), a manufacturer 720 (FIG. 7) or a general description such as “series 1200 loader” rather than the specific serial number.

Sometimes the desired identification 1100 (FIG. 11) is not immediately known. A selection 1110 may be made to ask for help in obtaining the serial number. In some embodiments, the identification may be obtained by the computing device 101. Examples include RFID tags and other tags that may be read by near field communication enabled phones. Near field communication schemes may be used to obtain information about the object 700 such as the manufacturer, the series, the make, the serial number, etc. Near Field Communication utilizes electromagnetic radio fields while technologies such as Bluetooth and Wi-Fi focus on radio transmissions instead. More information on near field communication schemes may be found at http://www.nearfieldcommunication.org/.

In additional, codes on the object 700 may be read that may provide information about the object. The code may be bar codes or UPC, QR and Data Matrix codes. A dedicated digital camera or a camera that is in communication with the computing device such as a camera in a smart phone may be used to read the code. In some embodiments, a module may be available locally to translate the code into a more familiar form such as a serial number. In other embodiment, the image of the code may be communicated to a central computing location such as a cloud of computing devices where the code may be translated into a more useful form.

In yet another embodiment, radio transmission devices may be used to communicate information about the object 700 to the computing device. For example, the object 700 which may be an excavator may have a wireless transmitter that may communicate with an authorized computing device. The information may be identification 1100 data plus additional data such as data from the engine control module or other computing devices, generically referred to as an equipment control module (ECM).

In some embodiments, the object 700 may use satellite communications to communicate data. In yet another embodiment, the object 700 may rely on cellular communication to communicate data when in range of a cell tower or a cellular phone that has been configured to communicate data on behalf of the object. In some embodiments, data may be pushed from the object 700 and stored over time as the communications are received rather than having the data pulled when an inspection is in progress.

In yet another embodiment, the object 700 may have a wired communication port which may allow the object 700 to communicate with the computing device. The port may be an Ethernet port, an ECM port or any other appropriate port that facilitate communication between the object 700 and the computing device. A wired connection may be made between the object 700 and the computing device and the devices may communicate identification 1100 data and other data as may be appropriate such as maintenance data, usage data, location data, etc.

In some embodiments, the application to determine identification 1100 data may be on the local computing device and in other embodiments, the application may be local. In some instances, the application may be able to determine extremely detailed identification 1100 data about the object 700 such as a serial number. In other embodiments, less detailed identification 1100 data may be determined such as a manufacturer 720, a model 710 and options.

The identification may occur in a variety of ways. In some embodiments, details may be listed on the object 700 and the details may be determined by zooming in on the listing of details. In other embodiments, the object 700 may be analyzed sand compared to previously identified objects. As an example, if an excavator has a wheel rim painted with polka dots, it is likely that a picture in the future that has a wheel rim with polka dots is like the same excavator. Similarly, a certain design elements may be changed from year to year and the presence or lack of these elements may be used to determine a year for the object. Similar assumptions may be made depending on the object, the number of objects created each year, etc.

In other embodiments, such as when a serial number cannot be located or is otherwise unavailable, a central host of object 700 data may be used to narrow down the possible models. As an example, someone examining the object 700 may be instructed to look at the engine block to determine if a code is part of the engine block and the engine code may be used to identify the object. In other embodiments, it may be known that a specific object 700 has a new rear tire and the tire on the object 700 in question may be examined to determine if the object 700 has a new rear tire. Depending on the object, the central server may pose questions to assist in narrowing down the identification of the object.

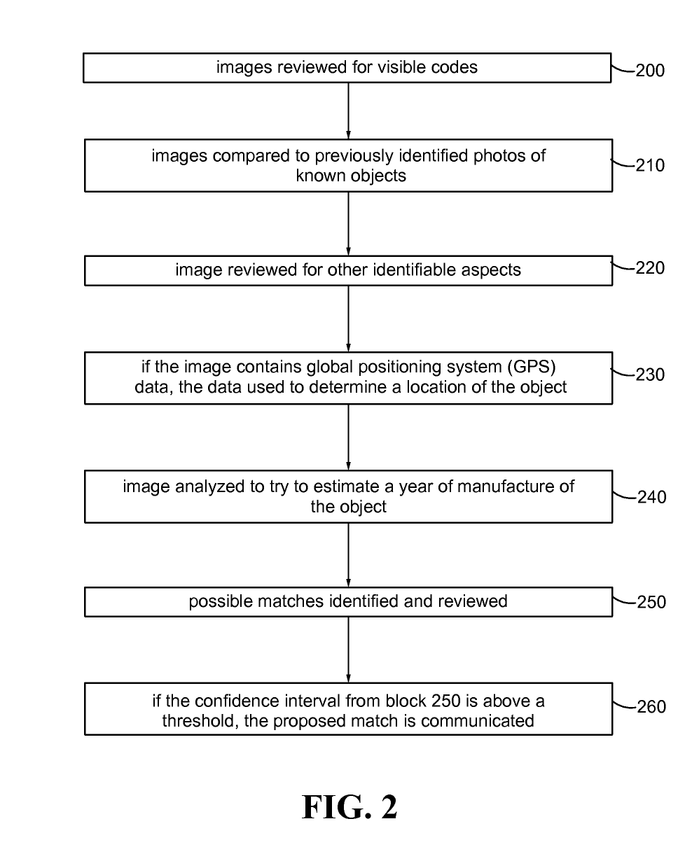

FIG. 2 may illustrate one method of analyzing a photo or video for identification 1100 data. At block 200, an image 701 (FIG. 7) or images of the physical object 700 may be reviewed for visible codes. Sample visible codes include model numbers 710, manufacturers 720 year numbers, registration plates, ownership information, or even serial numbers. The codes may be in a variety of languages and in a variety of formats.

At block 210, if an identification has not yet been made, the image 701 or images made be compared to previously identified photos of known objects. The comparison may be based on a variety of factors such as color, size, generic numbers, options that have been added, etc. If a match between a known object 700 and the object 700 in the images, then the object 700 may be proposed to be the known object.

At block 220, the image 701 may be reviewed for other identifiable aspects. In some embodiments, a background may be analyzed to determine if there are similarities to a known background with a known object. For example, if a known fork lift is in an image 701 of a known foundry, then an image 701 of a fork lift at the same foundry may be assumed to be the same known fork lift. Similarly, if an image 701 has a corporate name, then the name may be used to search a database for vehicles known to be owned by the corporation. Of course, other matches may be used to search the database for information about the owner or serial number of an object.

At block 230, if the image 701 contains global positioning system (GPS) data, the data may be used to try to determine a location of the object. The location may be used to search a database of information on the object. For example, the GPS location may match an owner's address for the object 700 or a previous image 1700 of a known object 700 may have been taken at the same GPS location. The matching data may be used to identify if the object 700 in the image 1700 is the same as the known object 700 at a similar GPS location.

At block 240, the image 701 may be analyzed to try to estimate a year of manufacture of the object. The year may be useful in classifying the object. As object 700 have changes from year to year, the year may be used to further narrow down the identification 700 of the object.

At block 250, the possible matches identified may be reviewed. A confidence interval may be determined that relates to the confidence that the submitted image 701 contains the same object 700 as the known object. The confidence interval may be related to the closeness of the match between the two objects (known and image).

At block 260, if the confidence interval from block 250 is above a threshold, the proposed match may be communicated. The match may be reviewed and approved or declined. In addition, if the match is accepted, the data may be stored that the image 1700 has a known object. Similarly, if the match is declined, the negative data may also be stored.

If the computing device has network access, identification 1100 data may be inputted and used to obtain additional data, such as past maintenance about the machine being inspected. As an example, it may be unclear when a fuel filter was last changed on an object. Using the identification 1100 data, maintenance information about the object 700 may be obtained. In this way, it may be determined when the fuel filter was last changed to avoid an unnecessary fuel filter change.

In some embodiments, the past data may be added to the form. As an example, past answers to questions may be displayed in one or more separate columns or row next to the open space for answer to those questions. In other embodiments, past answers may be displayed in a faint color such as grey. In this way, an inspector may be notified to take special care in observing past problems or past solutions.

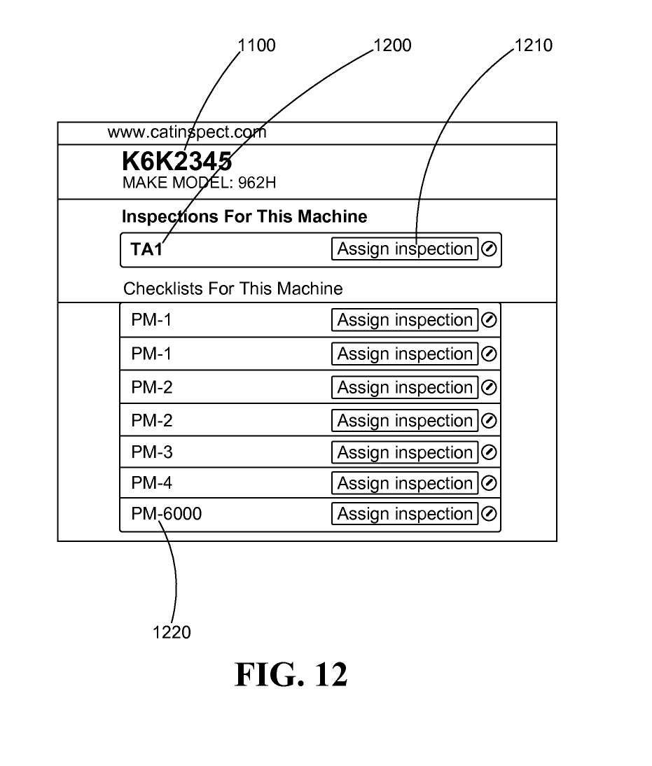

Referring again to FIG. 1, at block 110, an inspection form 1200 (FIG. 12) may be selected from a plurality of inspection forms based on the identification 1100 of the physical object. As an example, an inspection form 1200 for a house would not be logical to be used on an excavator. Similarly, an inspection form 1200 for an excavator would make little sense when a dump truck has been identified. Further, the level of review may also be used to determine the proper inspection 1200 form. As an example, an overhaul inspection form 1200 may be significantly more detailed than a review used between shifts of a new device.

In some embodiments, the inspection form 1200 may be stored locally and in other embodiments, inspection form 1200 downloaded from a central server 141. In some embodiments, if a specific inspection form 1200 is not available, a generic inspection form 1200 may be used and the generic form 1200 may then be transformed into the desired specific form 1200 by matching up fields between the two inspection forms 1200.

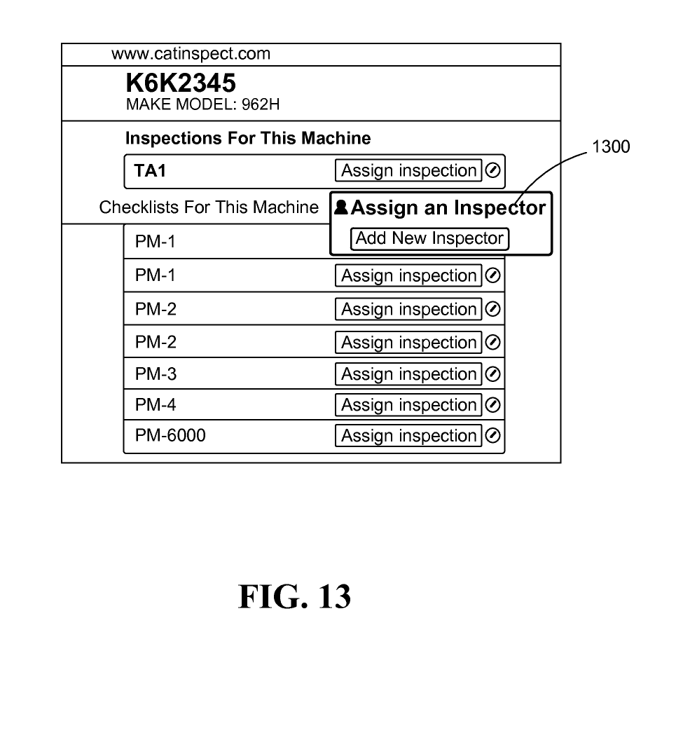

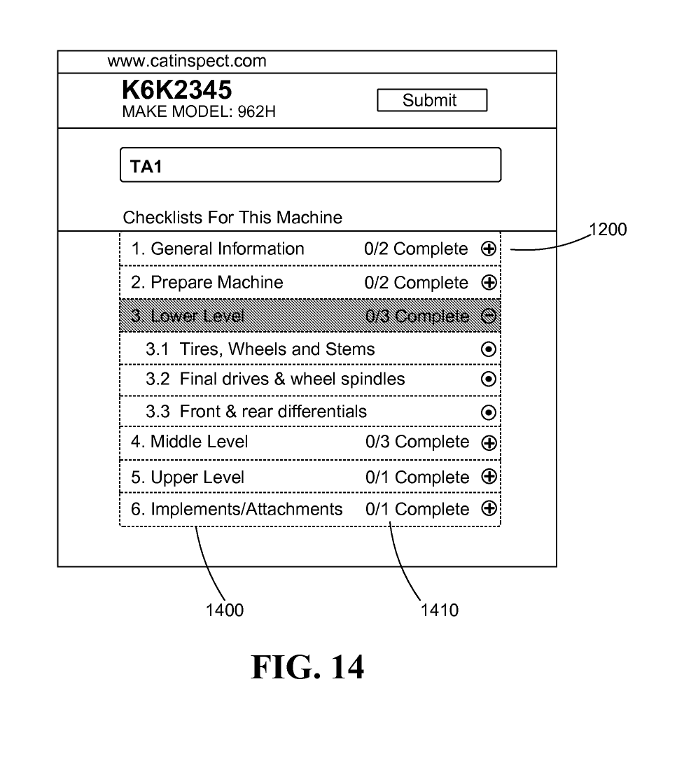

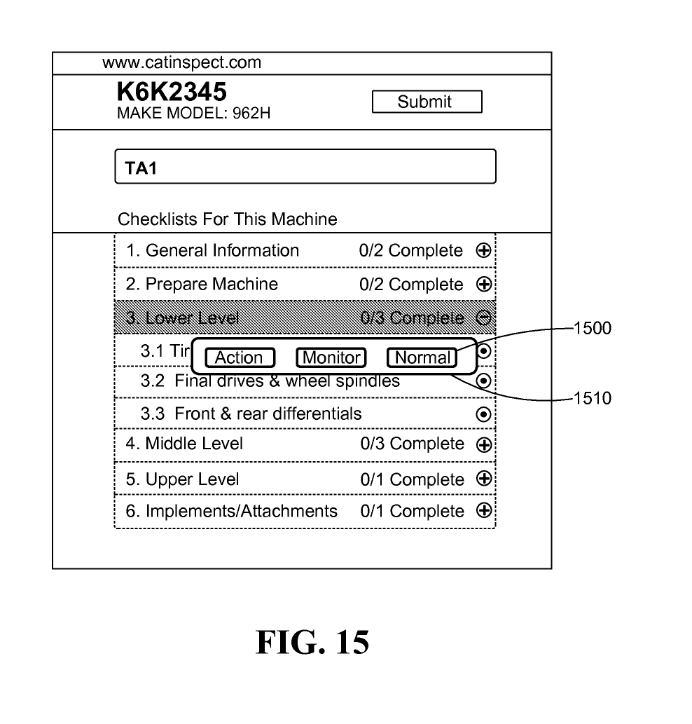

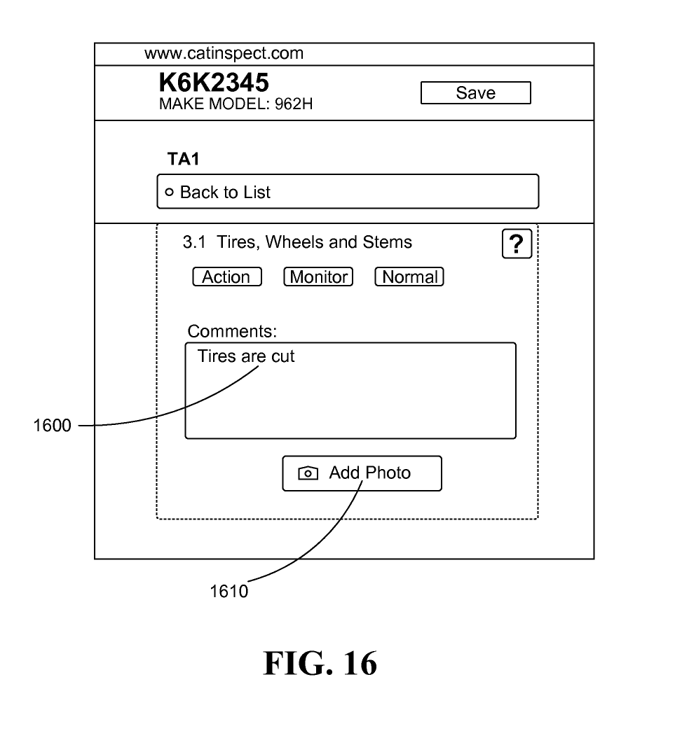

In general, the electronic form 1200 may be a series of questions or checklists 1220 and responses may be provided as electronic input. FIGS. 11-17 may be examples of sample electronic forms. The answers to the form 1200 may occur in a variety of ways. In some embodiments, the answers may be submitted in a variety of manners, from selecting an action button 1500 on a popup window 1510, selecting an option from a drop down box, one or more check boxes, entering text, attaching a photo, attaching a sound file, attaching a video, etc. In some embodiments, selecting a button such as “Not Applicable” may eliminate the need to respond to later questions. Questions may be answered in any order and pages of the questionnaire 1220 may be flipped through out of order.

The forms may be created by virtually any interested party. For example, the forms may be created by the object 700 creator such as a manufacturer. In other embodiments, the forms may be created by the current object 700 owner and in yet additional embodiments, the forms may be created by a maintenance provider. In addition, existing forms may be copied and edited by any user with the proper permissions. In the forms, there also may be space to addition additional comments by selecting to add additional comments.

At block 115, the inspection form 1200 may be displayed in the inspection application. As may be seen from FIG. 11-17, the questions may proceed logically depending on the object 700 and the level of detail required for the object. For example, if the object 700 is an elevator and the inspection is an annual inspection, the form 1200 may have a lot of detail. As another example, if the object 700 is a truck and the inspection is in between shifts, the inspection may not be as detailed. The questions 1400 may flow in a logical manner such as top to bottom or back to front. If the answer indicates there is a problem, the form 1200 may provide additional questions to obtain the necessary detail to address the problem. In addition, the form 1200 may indicate when a set of questions 1400 is complete 1410 or is open.

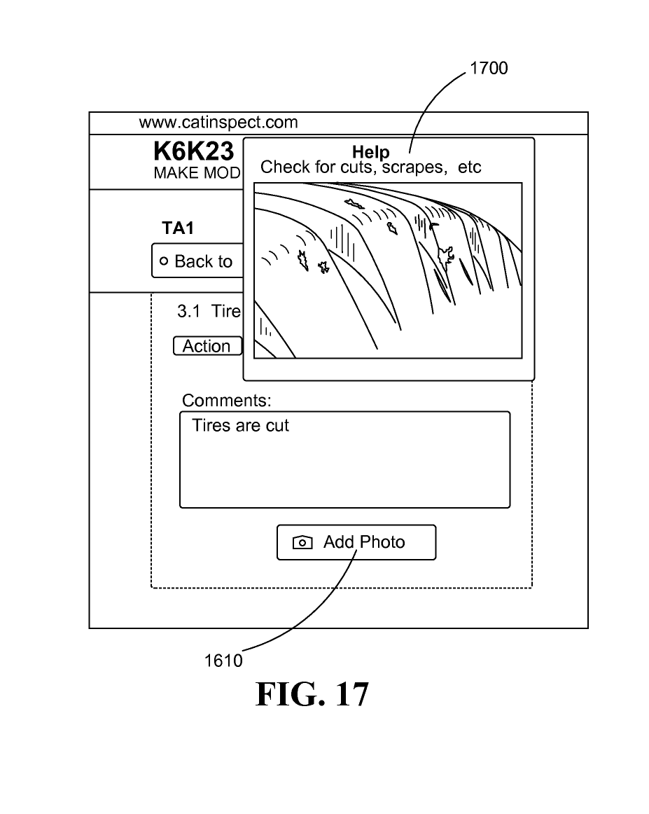

At block 120, inspection data 1600 from an inspector 1300 may be accepted for the physical object 700 into the inspection form 1200 in the inspection application on the computing device. In many instances, the inspection data 1600 may be entered using an input device such as a keyboard or a touch screen. However, the data may take on additional forms. For example, the inspection data 1600 may be a digital image 1700 (FIG. 17) taken with a digital camera 108 in communication with the computing device. Further, the digital image 1700 may be annotated such as adding circles, adding a sound file, highlighting elements, adding text, etc. Movies and sound recording may also be added.

The inspection data 1600 may also come from other devices that may take digital measurements or provide digital data. As an example, an ultrasound device may be used to inspect welds and the ultrasounds may be added as input data. Similarly, a vibration sensory may be used on a device and the measured data may be added as input data. Other logical measurements include temperature, pressure, thickness, depth, and the like. Virtual any measuring device may be used to provide input data.

In some embodiments, the electronic input may be reviewed to determine if the input is sufficient. As is often the case, users may be in a rush to complete an inspection. The application may review a response and note that a response was insufficient. The analysis may be based on a variety of factors. In some embodiments, past information may be used to guide whether a response is acceptable. For example, if a tire is listed in a past inspection as having a small cut and a response fails to note the tire condition, a message may be displayed that the response related to the tire was insufficient. Further, the application may request that a photo of the tire be submitted such that an authority may review the photo. Similarly, if the questions asks for a numeric oil level and a user responds with the word “fine” the application may repeat the question, specifically asking for a numeric reading of an oil level.

The progress 1410 through the inspection form 1200 may also be noted in the application. The progress may be noted in a variety of ways. In some examples, the form 1200 may simply say a page number or a page number out of a number of pages, such as page 3 of 7. In other embodiments, a bar may flow across a bottom with the bar progressing further as the user proceeds through the information form. Of course, there may be a variety of ways to indicate progress through the form 1200 and these are contemplated.

At block 125, the inspection data 1600 and the identification 1700 data may be stored in a memory on the computing device. The memory may be any known or future developed memories, such as magnetic storage devices, rotating memory devices, flash memories and the like. In addition, the inspection data 1600 and identification 1700 data may be stored remotely, such as in a data cloud.

When the data is stored in a cloud, inspection data 1600 may be added on a first computing device and additional inspection data 1600 related to the inspection data 1600 may be added to the inspection data 1600 at a later time. For example, a button 1610 may allow adding a photograph of the physical object 700, or one of its components. As the data is in the cloud, it may be accessed by a variety of devices and with the proper authorization, the data may be edited, added to, deleted, etc., as if the inspection was started on the second device.

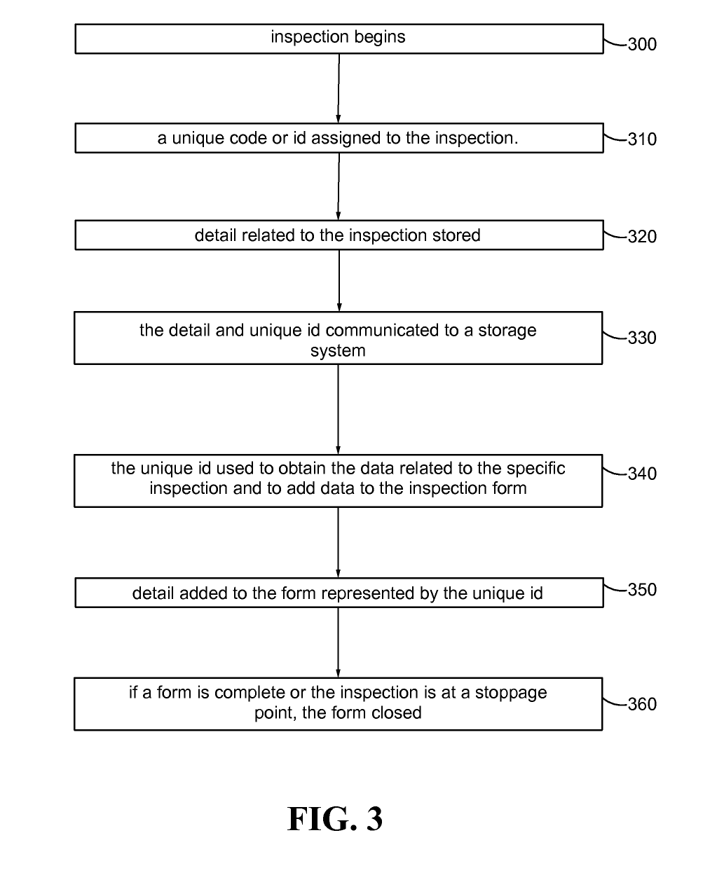

FIG. 3 may illustrate one embodiment of a manner of storing the data from the inspection. At block 300, the inspection may begin. The inspection may follow a form 1200 that is related to the object 700 to be reviewed. The form 1200 may direct the inspector on the proper manner to execute the inspection such as start at the rear, inspect the electrical systems last, make sure the engine is cool before checking fluid levels, etc.

At block 310, a unique code or id may be assigned to the inspection. The id may be used in the future to identify the inspection such that the details of the inspection may be recalled and reviewed. In addition, the unique id may be used to ensure that the details of the inspection are not mixed with other inspections that may occur the same day. The id may be generated in virtually any logical manner such as using sequential numbers, sequence code mixed with date codes, random numbers, etc.

At block 320, detail related to the inspection may be stored. The detail may be stored as data inputted to the HTML5 form 1200 and may be stored in a variety of manners such as an XML file, a flat file, a text file, etc. The detail may be the unique id and the answers to the questions on the form. Even if the form 1200 is not completed, the data may be stored such that the partially completed form 1200 may be accessed again in the future.

At block 330, the detail and unique id may be communicated to a storage system such as a cloud storage system. The communication may occur in a variety of ways, from satellite communication, to cellular communication to wifi communication to wired communication. Virtually any communication system may be used so long as the security system has a way to enable secure communication and to reliably communicate the data in a relatively prompt manner. The cloud storage system may be a proprietary system or a system operated by another. In general, cloud systems are known and have a variety of servers around that world that store and communicate data. The cloud may be accessed by network communication and may be available at any time from any place by anyone with security to access the data. Such cloud services are available through any number of commercial cloud resource providers.

At block 340, the unique id may be used to obtain the data related to the specific inspection and to continue to add data to the inspection form. The form 1200 may accessed by any qualified user, at any time using any device from any location as long as the location has a form of network access. At block 350, more detail may be added to the form 1200 represented by the unique id. As an example, if an object 700 is too hot to be examined, the form 1200 may be closed and the later, when the object 700 is cooler, the form 1200 may be accessed again using the unique id and the needed data may be added. The form 1200 may begin at the point where data was last entered

At block 360, if a form 1200 is complete or the inspection is at a stoppage point, the form 1200 may be closed. If the form 1200 is complete, a notification may be communicate to an authority that a complete inspection is on file and is ready for review. If the form 1200 is not complete, it may be added to a docket system that may remind the inspector to complete the form 1200 in a timely manner

Other information may be stored with the data. Each instance of stored formatted inspection data 1600 may be given a unique identifier and/or a date identifier. In addition, machine specific data may also be stored as additional inspection data 1600. In this way, the data for a specific machine may be searched and reviewed. Similarly, each inspection may have an identifier and may be searched and reviewed.

At block 130, the inspection data 1600 and identification 1700 data may be formatted or arranged into a formatted inspection data 1600. The formatted inspection data 1600 may be inspection data 1600 modified into a common format that may be understood by a variety of applications. The format may be a format that integrates easily with HTML5 or any other appropriate format.

At block 135, the formatted inspection data 1600 may be stored in a memory on the computing device. Formatting the data has many benefits. The formatted data may be stored in a smaller space. The formatted data may be easier to communicate and share as all parties receiving the data may understand the structure of the data and may be able to quickly interpret that data as the structure of the data is known. As also is common, error correction may be improved as the structure of the data may make errors clear such as when an alpha character is located in a spot that is meant to be a numeric entry.

At block 140, if the computing device is connected to a network, the formatted inspection data 1600 may be communicated to a central storage. The central storage may be a remote server or plurality of servers that are available to qualified users through a network connection. In some embodiments, the central storage may be a cloud type storage where the data is stored in a variety of places but is available to qualified users from virtually any location with qualified network access.

The inspection data 1600 and other data may be stored in a variety of manners such as a flat file, as an ASCII file, as separate files or in a database. The embodiment in which the data is stored in a database, the data may be sorted and queried in a variety of ways by a variety of users which may result in the system being even more flexible and useful.

At block 145, the formatted inspection data 1600 may be analyzed by one or more analytical tools. The analytical tools may take on a variety of forms, perform a variety of tasks, and look at the data in a variety of ways. Further, the analysis may depend on the object 700 in question. As an obvious example, a twenty year old earthmover may use different analytical tools than a month old fork lift.

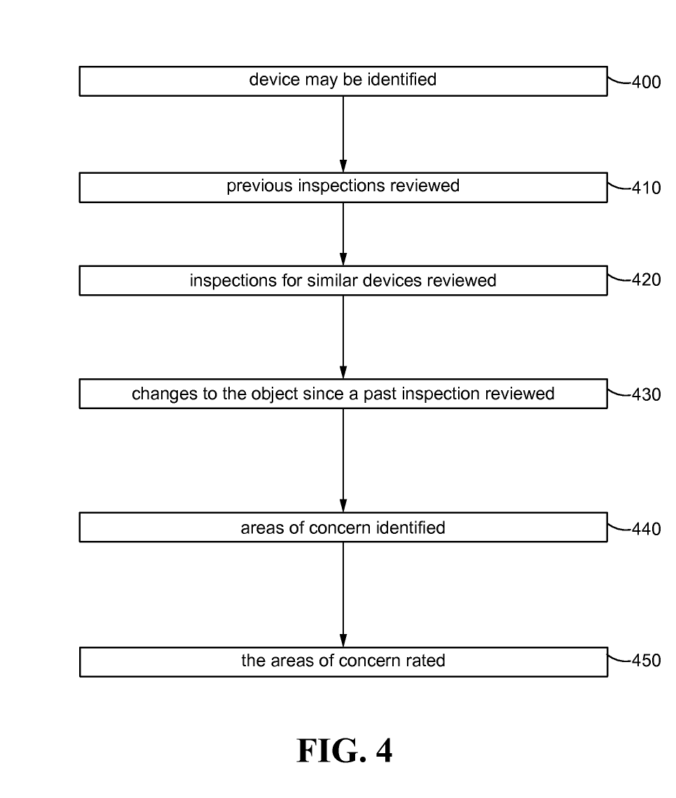

FIG. 4 may illustrate a sample analytical tool. In some embodiments, known analytical tools may be used. In other embodiment, analytical tools may be created for specific forms or devices. At block 400, a device may be identified. The identification 1700 may be the serial number of the object 700 or other unique code used to identify the object. In addition, the identification 1700 may be obtained by querying a database using other known information such as the unique id of a past inspection.

At block 410, previous inspections may be reviewed. The review may be manual or the application may highlight areas of concern. The areas of concern may be areas that were indicated as areas of concern in the last inspection or may be areas that are due to require special attention due to the amount of usage, the passage of time, the type of use, problems with similar devices, etc.

At block 420, inspections for similar devices may be reviewed. Vital information may be learned by reviewing inspections of similar devices. As an example, a batch of excavators may have hoses prone to bursting in cold temperatures. Such knowledge may only be obtained by reviewing the inspections of similar excavators. As such, special attention may be given to the hoses on the excavator, especially if the excavator has been exposed to cold weather. Additional applications or modules may be used to determine if issues from one model of objects may indicate that similar objects be inspected for similar issues.

At block 430, changes to the object 700 since a past inspection may be reviewed. As the changes likely have not been reviewed previously, the changes likely will require additional attention. In addition, as modifications may have been done by non-qualified technician and the work may deserve special attention. Further, a baseline inspection of the changes may be useful in future.

At block 440, areas of concern may be identified. The areas of concern may be determined in a variety of ways. In some embodiments, the areas of concern may be identified by reviewing the history of the device, the history of similar devices and any past areas of concern. The application may take into account the work environment, the hours the object 700 was used, the hours since the last inspection and the results of past inspections to determine areas of concern.

At block 450, the areas of concern may be rated. The rating may be based on a variety of factors but may take into account the potential danger of not addressing the area of concern. In addition, other factors may be taken into account such as the likelihood of a serious incident, the cost of the repair, the time to make the repair, the availability of the parts, etc. The areas of concern may be graded and sorted in a several different ways, such as possible cost, possible time to repair, possible difficult to fix, possibly downtime to repair, etc. The rating may be personalized or may be created by the manufacturer. Of course, the number and options in creating the rating are limited only by the creativity of the designer.

At block 150, it may be determining if additional review of the formatted inspection data 1600 is required. The analytical tool may flag items that may need analysis beyond what it can offer. In some situations, a human with expertise, such as an inspector, dealer, engineer or other skilled person may need to review the situation. In such situations, the application may calculate a confidence level that an analysis is correct or that a trained professional should become involved. If the determined confidence is above a threshold, a notification may be created to have an additional professional become involved.

At block 155, if additional review is determined at block 150, a notification that additional review is required may be communicated. Logically, the notification may be communicated to the people in the field making the inspection. In this way, users will know that an issue may exist and that special care may be required with the object 700 in question.

In addition, the application may make a determination of any additional people needed to receive the communication and many factors may be weighed when making this determination. For example, if a particular dealer has been performing maintenance on a device, then that particular dealer may be notified that an in person inspection is required. In other situations, a certain inspector may be an expert in the field at question and may be in the proper geographic area and that inspector may be notified that an inspection is required. Similarly, the calendar, skills and availability of an inspector may be analyzed to determine the proper inspector to be notified that an inspection is required.

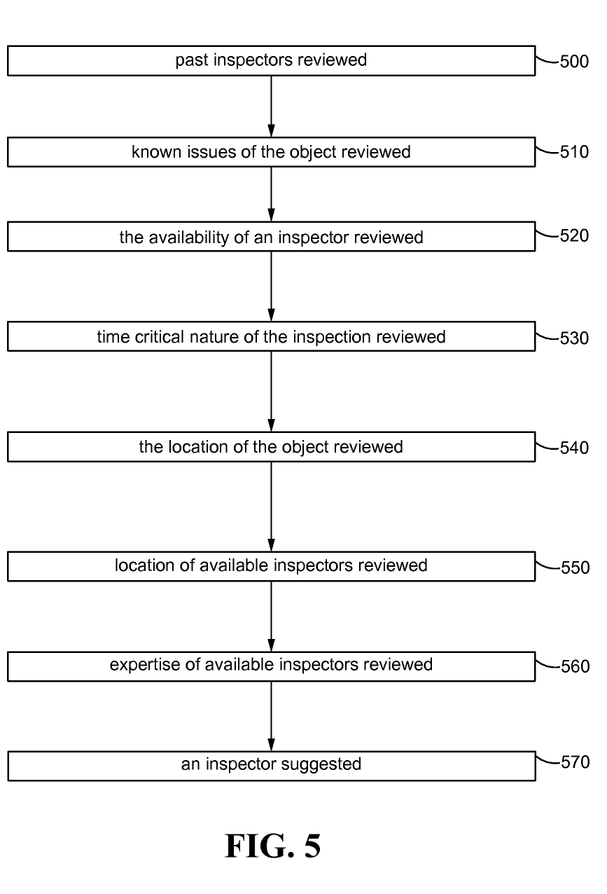

FIG. 5 may illustrate one of the many embodiments of selecting an inspector. At block 500, past inspectors may be reviewed. It may be beneficial to have the same inspector reviewing an object 700 as that inspector may recall the details of the object. Thus, it may be of benefit to have the same inspector review the object. In some embodiment, an inspector may simply be selected or assigned.

At block 510, known issues of the object 700 may be reviewed. The known issues may be obtained from a current inspection report, a past inspection report or from reports received from the device. The review of the known issues may be useful as certain inspectors may have skills more suited to certain issues than others. In fact, some inspectors may be completely unable to assess certain issues but may be extremely skilled at assessing other issues.

At block 520, the availability of an inspector may be reviewed. An inspector may already have inspections scheduled and may not be available during the time needed. Related, at block 530, time critical nature of the inspection may be reviewed. For example, if an entire mine will not operate until an object 700 is inspected, previous appointments of an inspector may be canceled.

At block 540, the location of the object 700 may be reviewed. The location may be used to determine which inspector is in close enough proximity to complete the inspection in a timely manner. Related, at block 550, the location of available inspectors may be reviewed. Ideally, inspectors will be at a similar location to the objects to be inspected. In some embodiments, an inspector may need to be flown in to the object. At block 560, the expertise of available inspectors may be reviewed. Even if an inspector is nearby and available, the inspector may not have the desired skills. Thus, another inspector may be selected that better matches the desired expertise.

At block 570, an inspector may be suggested. The suggestion may weigh all the factors from blocks 500-560 and suggest an inspector. There may be a variety of manners of selecting one inspector from a plurality of inspectors. For example, in some embodiments, cost may be given a bigger weight while in other situations, speed of inspection may be given a greater weight. Different situations may call for different inspection selection strategies.

If additional review is required, the pending form 1200 may have a place 1210 for the results of the additional inspection. In other embodiments, a new form 1200 is used to collect the supplemental data on the object. In either case, the proper form 1200 is communicated to the selected professional and the completed form 1200 is expected to be returned.

At block 160, it may be determined if modifications of the physical object 700 are required. Physical modifications often require a trained professional in order for the modification to be performed correctly and to not void any warranties. Further, issues that a new operator of an object 700 may believe are minor or trivial may actually be of great importance. Thus, the application may make a decision whether a physical object 700 needs to be modified.

At block 165, if the physical object 700 requires modification, notifications may be created that the physical modification has been determined to be necessary. Logically, the requirement of a physical modification may first be communicated to the inspector that created the report. In addition, the requirement may be communicated to the owners of the object. In this way, the necessity of the modification may quickly be passed on such that the equipment will not be used in any potentially dangerous manners.

Similar to the additional review requirement of block 155, the selection of the proper people to notify of the requirement of the physical modification may be a process. The process may take into account numerous factors and weigh these factors before making an assignment of the physical modification. For example, the process may review professional skills, availability, physical location, familiarity with the device, relationship with the owner, warrantee status, etc.

The analytical application may perform even more functions that just reviewing case by case inspection reports. The analytical applications may also take a larger view and try to identify trends with objects. For example, if hoses from a certain batch begin to burst, the analytical systems may determine that all hoses from the batch should be inspected. Similarly, the analytical applications may take into account even more data to try to understand past issues but also be proactive in trying to predict future incidents and trying to provide suggestions to avoid such future incidents.

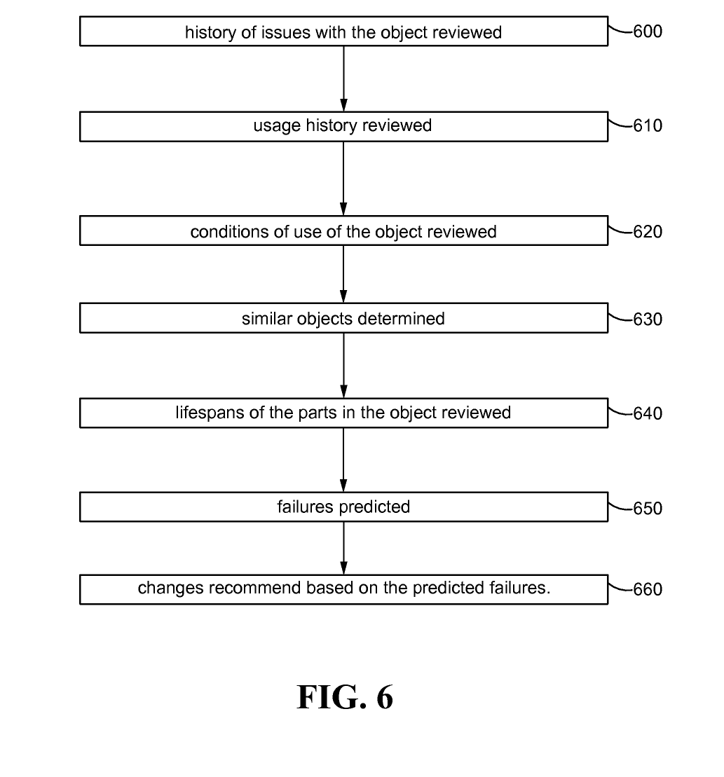

FIG. 6 may illustrate at a high level a sample proactive analytical system. At block 600, the history of issues with the object 700 model may be reviewed. The past history may be useful in predicting issues in the future. For example, if a hose is known to crack after 10,000 hours of use and the device is at 9,980 hours, it is likely that a hose may crack soon.

At block 610, a usage history may be reviewed. The usage history may indicate whether a failure is likely in the near future based on the usage. For example, an excavator that has been used at its maximum will likely have issues before an excavator that has been used in a leisurely manner. At block 620, the conditions of use of the object 700 may be reviewed. Harsher conditions may indicate that an issue may occur soon that if the object 700 had been used in lighter conditions.

At block 630, similar objects may be determined. The similarities may be based on a variety of factors such as those in block 610-620. The age of the object 700 and the type of use may also be considered but empirical study may indicate that certain factors have more importance than others. At block 640, lifespans of the parts in the object 700 may be reviewed. In addition, observed lifespans in similar older devices may be used to predict lifespan in newer devices.

At block 650, failures may be predicted based on blocks 610-640 and at block 660, changes may be recommend based on the predicted failures. The changes recommended may be based on a variety of factors such as cost, potential danger, time to repair, parts needed, experts needed to install the parts, expected downtimes for the object, etc.

Completed inspections form 1200 may be saved in any manner (Word, pdf, ASCII, etc.) and may be printed. The inspections may also be emailed directly from the computing device. The inspections may be available as described previously or at a specific web site if a user has acceptable security. Once the inspection data 1200 is communicated to a network server 141 or cloud, the inspection data 1200 may be available virtually immediately to all qualified users of the network cloud. In addition, data about other related devices may be stored with the inspection form 1200, even if the device is not on the network 141.

Cost estimates also may be determined by the system. Once the recommended repairs are determined, the cost of the necessary parts may be calculated. Similarly, the amount of labor required to perform the recommended repair may also be known. Assuming some standard labor rates, the cost to perform the repair may also be provided. The cost estimates may be even further refined depending on the expertise required, the labor rates for the expertise, whether additional labors will be required, etc.

Scheduling also may be handled by the application. As the recommended services may be known, the skills and personnel needed to perform the services may be known and the parts needed are known, the availability of all the things needed to address an issue may be determined. Parts may take some time to be delivered and having the proper people ready to install the parts in a timely manner may be of critical importance. As a result, the delivery of the part may be matched up with the available service personnel to schedule the needed services. Logically, if additional machinery is needed to move the object 700, the availability of such machinery may also be reviewed and scheduled.

The data 1200 may also be used to create a problem manual for the changes that may need to be made to the object 700. In the manual may be step by step instructions created specifically for the current issues with the object 700. The manual may be pages from appropriate owner's manuals or may be photos from similar projects performed on similar objects 700 in the past or a manufacture may create drawings and instructions specifically for the problem at hand. The manual may be electronically communicated to a technician or to an owner. As a result, issues with the object 700 may be tended to in an even quicker and efficient manner as the technician will have tailored direction for the object 700 at hand.

Security also may be used by the application. A security module may be used to restrict access to the data related to the inspections and the objects. For example, a portable computing device 101 may include a smart chip (not depicted) available from a number of manufacturers, such as Infineon and STMicroelectronics may be coupled to a processor 900 via an ISO 9816 protocol bus. Owners and customers may only be allowed to view data on their own devices. Dealers may have additional rights to see data about objects they have sold or objects they have serviced. In addition, dealers may be able to obtain data about similar objects with similar problems and the dealer may be able to review the manner in which the other dealers fixed those problems. Of course, dealers may be restricted from seeing identification 1700 information for devices to which they have no relation. Similarly, inspectors may see even more data about objects as inspectors are tasked with finding and viewing key aspects of the object 700 and some of the key aspects may not be apparent by simply looking at a vehicle. As an example, a vehicle may have been in an accident and the results of the accident may only be apparent if the accident is known to the inspector.

Finally, manufacturers may also have access to the inspection data 1600. The data may be used for a variety of purposes. In some situations, the inspection reports may ensure that an owner is taking the proper steps as described in a warranty. In other embodiments, the manufacturer may use the data to proactively recommend changes and modifications to an object 700 based on the life of the object, the use of the object, the known issues with similar objects, etc. Finally, the inspection data 1600 may be used as a possible sales tool to identify objects that are due to be replaced or rebuilt.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A method of collecting inspection data for a physical object comprising:
executing an inspection application for the physical object via a computing device wherein the inspection application may execute if the computing device is not in communication with a network;
determining an identification for the physical object to be inspected;
selecting an inspection form from a plurality of inspection forms based on the identification of the physical object;
displaying the inspection form in the inspection application;
accepting inspection data for the physical object into the inspection form in the inspection application on the computing device;
communicating the inspection data via a network;
arranging the inspection data and the identification into a formatted inspection data wherein the formatted inspection data comprise inspection data modified into a common format;
storing the formatted inspection data in a memory remote from the computing device;
analyzing the formatted inspection data, the analysis comprising:
determining a status of the item;
sending a notification based on the status;
determining if modifications of the physical object are required; and
if the physical object requires a modification, creating notifications that the modification has been determined to be necessary.

2. The method of claim 1, wherein the inspection data comprises at least one digital image.

3. The method of claim 2, wherein the digital image is taken with a portable computing device.

4. The method of claim 3, wherein the digital image may be annotated using the inspection application.

5. The method of claim 4, wherein the inspection data comprises measured data from a digital device in communication with the portable computing device.

6. The method of claim 5, wherein if the computing device has network access, identification data may be inputted and used to obtain additional data about the physical object being inspected.

7. The method of claim 1, wherein past data about the physical object may be reviewed on a portable computing device.

8. The method of claim 1, wherein a security module ensures qualified applicants may access the inspection application.

9. The method of claim 1, further comprising obtaining machine specific data and storing the data as additional inspection data.

10. The method of claim 9, wherein machine specific data comprises equipment control module information.

11. An inspection application using computer executable instructions stored in a non-volatile memory that when executed on a processor of a portable computing device cause the processor to:
receive information related to a physical object;
determine an identification for the physical object using the information;
select an inspection form from a plurality of inspection forms;
display the inspection form in the inspection application;
accept inspection data for the physical object into the inspection form in the inspection application on the portable computing device;
store the inspection data and the identification in a memory on the portable computing device;
send the inspection data to a server via a network;
receive an incoming notification from the server via the network that additional inspection is required;
determine a party required to perform the additional inspection; and
send a notification to the party.

12. The inspection application of claim 11, having further instructions that cause the processor to:
determine that a physical modification to the physical object are required; and
create notifications that the physical modification has been determined to be necessary.

13. The inspection application of claim 11, wherein to accept the inspection data comprises to accept inspection data having a rating of a condition of a component.

14. The inspection application of claim 11, having further instructions that cause the processor to:
review a digital image in an inspection report for maintenance information and identity information data on the physical object.

15. The inspection application of claim 11, having further instructions that cause the processor to:
receive measured data from an other device in communication with the inspection application.

16. The inspection application of claim 15, wherein the other device is an ultrasound device used to capture weld integrity.

17. The inspection application of claim 11, having further instructions that cause the processor to:
determine an rating of an area of concern; and
recommending a repair based on the rating.

18. The inspection application of claim 11, wherein the party determined to be required to perform the additional inspection is one of a dealer and an expert inspector.

19. A method of reviewing a digital image in an inspection report for maintenance data on a device comprising a plurality of components comprising:
reviewing the inspection report for digital images of the device;
if the digital image is attached, analyzing the digital image for identification data of the device comprising:
if a manufacturer of the device is not known, analyzing the digital image for data indicating the manufacturer;
if the manufacturer cannot be determined from the digital image:
comparing the device to known devices;
selecting a best match of known devices as the determined manufacturer of the device;
storing the determined manufacturer in a memory;
augmenting the inspection report with the determined manufacturer.
if a model of the device is not known, analyzing the digital image for data indicating the model;
if the model cannot be determined from the digital image:
comparing the device to known devices;
selecting the best match of known devices as the determined model of the device;
storing the determined model in the memory;
augmenting the inspection report with the determined model;
if a year of the device is not known, analyzing the digital image for year data;
if the year cannot be determined from the digital image:
comparing the device to known devices;
selecting the best match of known devices as the determined year of the device;
storing the determined year in a the memory;
augmenting the inspection report with the determined year;
if a serial number of the device is not known, analyzing the digital image for data indicating the serial number;
if the serial number cannot be determined from the digital image:
comparing the device to known devices;
selecting the best match of known devices as the determined serial number of the device;
storing the determined serial number in the memory; and
augmenting the inspection report with the determined serial number.

20. The method of claim 19, further comprising:
reviewing the digital image for additional possible issues comprising:
searching for wear indications;
searching for damage indications;
storing the additional possible issues in the memory;
augmenting the inspection report with the additional possible issues;
reviewing the inspection report for possible issues;
analyzing the digital image for additional issue data related to the possible issues;
storing the additional issue data in the memory;
augmenting the inspection report with the additional issue data, and
presenting the inspection report with the augmented inspection report to an inspector and an owner.
